(19) United States
(12) Patent Application Publication
(10) Pub. No.: US 2026/0203047 A1
(43) Pub. Date: Jul. 16, 2026

(54) PARALLEL NODE UPGRADE IN HCI CLUSTER BASED ON FAULT TOLERANCE REDUNDANCY

(71) Applicant: Dell Products L.P., Round Rock, TX (US)

(72) Inventor: Feng GU, Shanghai (CN)

(73) Assignee: Dell Products L.P., Round Rock, TX (US)

(21) Appl. No.: 19/030,598

(22) Filed: Jan. 17, 2025

(30) Foreign Application Priority Data
Jan. 10, 2025 (CN) 202510040890.7

(51) Int. Cl. G06F 8/658; G06F 9/455

(52) U.S. Cl. CPC G06F 8/658; G06F 9/45558; G06F 2009/4557; G06F 2009/45595

(57) ABSTRACT

An information handling system may include at least one processor and a memory. The information handling system may be configured to perform an upgrade on a set of nodes of an information handling system cluster, wherein the cluster is executing a plurality of workloads, by: partitioning the set of nodes into an upgrade candidate group (UCG) and a non-UCG, wherein the UCG is determined such that every workload that is executing on a node in the UCG is also executing on a node in the non-UCG; upgrading the nodes in the UCG in parallel; triggering a resynchronization of the cluster after the upgrading is complete; and repeating the steps of partitioning, upgrading, and triggering until all nodes in the set of nodes have been upgraded.

### TECHNICAL FIELD

The present disclosure relates in general to information handling systems, and more particularly to accelerating upgrade events in a cluster environment such as a hyper-converged infrastructure (HCI) cluster.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware^{®}vSphere^{®}ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) or containerized workloads for various purposes. A VM or container may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Lifecycle management of cluster nodes provides full-stack software upgrade capabilities, which reduces maintenance costs and increases system stability. During such an upgrade, typically each node of a cluster may be upgraded (e.g., with upgrade components such as firmwares, drivers, application software, etc.). For system administrators, one important objective is to minimize the cluster upgrade time to reduce the impact on workloads.

One strategy to reduce cluster upgrade time is to upgrade all nodes in parallel. However, because physical nodes may need to enter maintenance mode and reboot during an upgrade, this is possible only when it is feasible to shut down all of the running workloads until the upgrade completes.

Otherwise, a rolling node upgrade strategy can be used to upgrade the nodes one by one, so that running containers or VMs can be temporarily moved to other nodes via live migration techniques, without impacting the workload. However, a pure rolling upgrade strategy means sequential node upgrades without any parallelism. Thus, embodiments of this disclosure provide techniques for enabling some level of parallelism in node upgrades without shutting down the running workloads.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with cluster upgrades may be reduced or eliminated.

In accordance with embodiments of the present disclosure, an information handling system may include at least one processor and a memory. The information handling system may be configured to perform an upgrade on a set of nodes of an information handling system cluster, wherein the cluster is executing a plurality of workloads, by: partitioning the set of nodes into an upgrade candidate group (UCG) and a non-UCG, wherein the UCG is determined such that every workload that is executing on a node in the UCG is also executing on a node in the non-UCG; upgrading the nodes in the UCG in parallel; triggering a resynchronization of the cluster after the upgrading is complete; and repeating the steps of partitioning, upgrading, and triggering until all nodes in the set of nodes have been upgraded.

In accordance with these and other embodiments of the present disclosure, a method for performing an upgrade on a set of nodes of an information handling system cluster, wherein the cluster is executing a plurality of workloads, may include: an information handling system partitioning the set of nodes into an upgrade candidate group (UCG) and a non-UCG, wherein the UCG is determined such that every workload that is executing on a node in the UCG is also executing on a node in the non-UCG; the information handling system upgrading the nodes in the UCG in parallel; the information handling system triggering a resynchronization of the cluster after the upgrading is complete; and the information handling system repeating the steps of partitioning, upgrading, and triggering until all nodes in the set of nodes have been upgraded.

In accordance with these and other embodiments of the present disclosure, an article of manufacture may include a non-transitory, computer-readable medium having computer-executable instructions thereon that are executable by a processor of an information handling system for: performing an upgrade on a set of nodes of an information handling system cluster, wherein the cluster is executing a plurality of workloads, by: partitioning the set of nodes into an upgrade candidate group (UCG) and a non-UCG, wherein the UCG is determined such that every workload that is executing on a node in the UCG is also executing on a node in the non-UCG; upgrading the nodes in the UCG in parallel; triggering a resynchronization of the cluster after the upgrading is complete; and repeating the steps of partitioning, upgrading, and triggering until all nodes in the set of nodes have been upgraded.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example method, in accordance with embodiments of the present disclosure.

### DETAILED DESCRIPTION

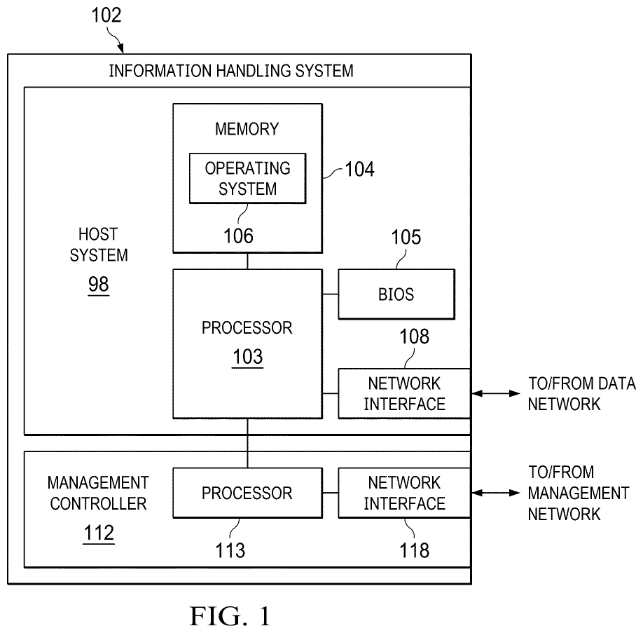

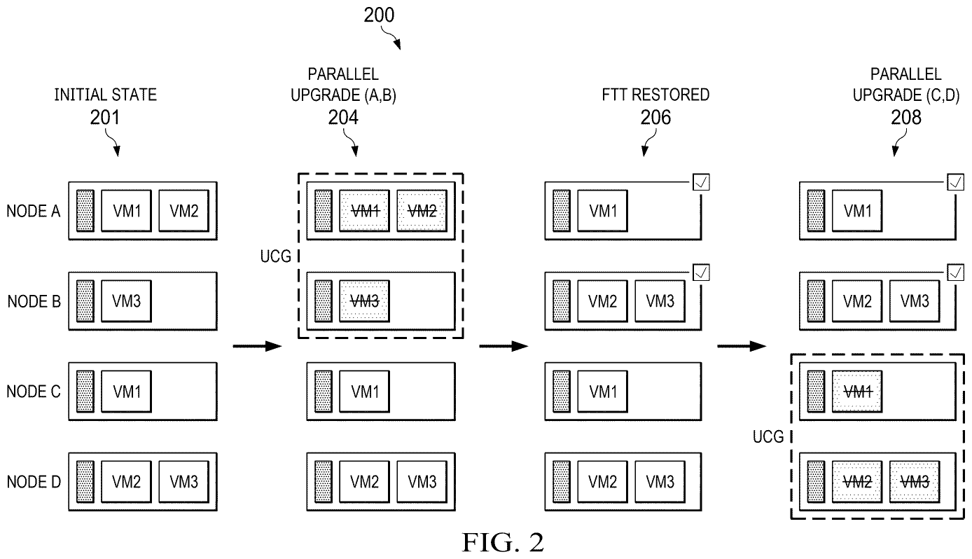

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, an HCI cluster may contain information handling system 102 as a node, and the cluster may be in need of an upgrade. The upgrade process may be managed by one of the nodes in the cluster or by an external information handling system.

Embodiments of this disclosure may be used to accelerate the upgrade process by leveraging the cluster's fault tolerance redundancy mechanism. Specifically, the cluster may have a property indicating the number of failures to tolerate (FTT). For example, if FTT=1, then any one node can fail without a loss of service. If FTT=2, then any two nodes can fail, etc.

In most real deployments, FTT=1, and so that is the example discussed in detail herein. For FTT=1, each workload must be hosted on (at least) two nodes. As discussed below, FTT compliance may be temporarily violated during an upgrade. For example, it is possible that for certain VMs and at certain times, only one data copy remains on the operational nodes (the ones that are not in the process of upgrading).

Embodiments may search for an upgrade candidate group (UCG) of nodes, which is specified by the condition that the UCG is not the only location that is currently hosting any particular VM. That is, what is desired is that when the UCG nodes are put into maintenance mode and upgraded, the remaining nodes (those not being concurrently upgraded) are still operable to host at least one copy of the data for all VMs, thus avoiding any VM shutdown.

The problem of determining the maximal UCG is equivalent to a variant of the classic set covering problem, which is known to be NP-hard. That is, the problem can be expressed as determining a minimal set of nodes that, together, include all running VMs. The complement of that set is the UCG.

For simplicity and performance reasons, a greedy searching heuristic algorithm may be used to generate the candidate groups in some embodiments. This greedy algorithm is not guaranteed to find the optimal UCG (the one with the maximum possible number of nodes). However, in practice, it has been found to give satisfactory results. Other algorithms may also be applied in some embodiments to balance the optimization between planning time and upgrading time. For example, in a small deployment, it may be feasible to use an exhaustive search algorithm that is guaranteed to find the optimal UCG, etc.

An example greedy algorithm may operate as follows:
1. Begin with an empty UCG.
2. For each node, determine whether copies of all of the VMs on that node exist in at least one other node that is not in the UCG. If true, then put that node into the UCG. If not, then do not put that node into the UCG.
3. Repeat step 2 with each node until no more candidate nodes exist.
4. Upgrade all of the nodes in the UCG in parallel.
5. When the upgrades of the UCG nodes are complete, trigger a cluster synchronization to restore the data copies in accordance with the FTT.
6. Repeat these steps until all nodes are upgraded.

Embodiments thus leverage a cluster's fault tolerance redundancy mechanism to upgrade nodes in parallel when possible, without impacting running VMs.

FIG. 2 illustrates a flowchart of an example upgrade method 200, according to some embodiments. As shown, the cluster includes four nodes A, B, C, and D, and various workloads are executing on VMs in those nodes.

Step 201 is the initial state of the cluster, with VM1 executing in Nodes A and C, VM2 executing in Nodes A and D, and VM3 executing in Nodes B and D. With each VM executing on two nodes, this situation has FTT=1.

The UCG is determined as above, and it includes Nodes A and B. The workloads on Nodes A and B are also present on other nodes, so it is safe to temporarily violate the FTT and put Nodes A and B into maintenance mode by shutting down their workloads. Nodes A and B are then upgraded in parallel at step 204.

At step 206, when the upgrade of Nodes A and B completes, an FTT synchronization is triggered so that an additional copy of all VMs are restored on Nodes A and B. When FTT is restored, repeat the process by searching the remaining nodes for a new UCG. Nodes C and D are identified as the new UCG at step 208 and are then upgraded in parallel.

All nodes have now been upgraded, and another FTT synchronization may be triggered to return the cluster to full operation.

One of ordinary skill in the art with the benefit of this disclosure will understand that the preferred initialization point for the method depicted in FIG. 2 and the order of the steps comprising that method may depend on the implementation chosen. In these and other embodiments, the method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system configured to perform an upgrade on a set of nodes of an information handling system cluster, wherein the cluster is executing a plurality of workloads, by:
partitioning the set of nodes into an upgrade candidate group (UCG) and a non-UCG, wherein the UCG is determined such that every workload that is executing on a node in the UCG is also executing on a node in the non-UCG;
upgrading the nodes in the UCG in parallel;
triggering a resynchronization of the cluster after the upgrading is complete; and
repeating the steps of partitioning, upgrading, and triggering until all nodes in the set of nodes have been upgraded.

2. The information handling system of claim 1, wherein the information handling system cluster is a hyper-converged infrastructure (HCI) system.

3. The information handling system of claim 1, wherein the partitioning comprises using a greedy algorithm.

4. The information handling system of claim 1, wherein the partitioning comprises using an exhaustive search algorithm.

5. The information handling system of claim 1, wherein the workloads execute in virtual machines (VMs).

6. The information handling system of claim 1, wherein the workloads execute in containers.

7. A method for performing an upgrade on a set of nodes of an information handling system cluster, wherein the cluster is executing a plurality of workloads, the method comprising:
an information handling system partitioning the set of nodes into an upgrade candidate group (UCG) and a non-UCG, wherein the UCG is determined such that every workload that is executing on a node in the UCG is also executing on a node in the non-UCG;
the information handling system upgrading the nodes in the UCG in parallel;
the information handling system triggering a resynchronization of the cluster after the upgrading is complete; and
the information handling system repeating the steps of partitioning, upgrading, and triggering until all nodes in the set of nodes have been upgraded.

8. The method of claim 7, wherein the information handling system cluster is a hyper-converged infrastructure (HCI) system.

9. The method of claim 7, wherein the partitioning comprises using a greedy algorithm.

10. The method of claim 7, wherein the partitioning comprises using an exhaustive search algorithm.

11. The method of claim 7, wherein the workloads execute in virtual machines (VMs).

12. The method of claim 7, wherein the workloads execute in containers.

13. An article of manufacture comprising a non-transitory, computer-readable medium having computer-executable instructions thereon that are executable by a processor of an information handling system for:
performing an upgrade on a set of nodes of an information handling system cluster, wherein the cluster is executing a plurality of workloads, by:
partitioning the set of nodes into an upgrade candidate group (UCG) and a non-UCG, wherein the UCG is determined such that every workload that is executing on a node in the UCG is also executing on a node in the non-UCG;
upgrading the nodes in the UCG in parallel;
triggering a resynchronization of the cluster after the upgrading is complete; and
repeating the steps of partitioning, upgrading, and triggering until all nodes in the set of nodes have been upgraded.

14. The article of manufacture of claim 13, wherein the information handling system cluster is a hyper-converged infrastructure (HCI) system.

15. The article of manufacture of claim 13, wherein the partitioning comprises using a greedy algorithm.

16. The article of manufacture of claim 13, wherein the partitioning comprises using an exhaustive search algorithm.

17. The article of manufacture of claim 13, wherein the workloads execute in virtual machines (VMs).

18. The article of manufacture of claim 13, wherein the workloads execute in containers.
